(19) United States
(12) Patent Application Publication
(10) Pub. No.: US 2015/0207988 A1
(43) Pub. Date: Jul. 23, 2015

(54) INTERACTIVE PANORAMIC PHOTOGRAPHY BASED ON COMBINED VISUAL AND INERTIAL ORIENTATION TRACKING

(71) Applicant: NVIDIA CORPORATION, Santa Clara, CA (US)

(72) Inventors: Colin TRACEY, San Jose, CA (US); Navjot GARG, San Jose, CA (US); Joshua ABBOTT, Raleigh, NC (US); Leonid BEYNENSON, Nizhny Novgorod (RU)

(73) Assignee: NVIDIA CORPORATION, Santa Clara, CA (US)

(21) Appl. No.: 14/162,312

(22) Filed: Jan. 23, 2014

(51) Int. Cl. H04N 5/232; G06T 11/60; G09G 5/377

(52) U.S. Cl. CPC H04N 5/23238; G09G 5/377; G06T 11/60; H04N 5/23293

(57) ABSTRACT

A panoramic image is generated from a plurality of source images. A panoramic analysis engine samples a first source image and a second source image included in the plurality of source images to generate a first proxy image and a second proxy image, respectively. The panoramic analysis engine samples inertial measurement information associated the two proxy images. The panoramic analysis engine detects a feature that is present in both the first proxy image and the second proxy image. The panoramic analysis engine blends the second proxy image into the first proxy image based on the inertial measurement information and a first position of the feature within the second proxy image relative to a second position of the feature within the first proxy image to generate a preview image. Finally, the panoramic analysis engine renders the preview image according to a first panoramic mode to generate a first partial display image.

### BACKGROUND OF THE INVENTION

1. Field of the Invention

Embodiments of the present invention generally relate to digital camera processing and, more specifically, to interactive panoramic photography based on combined visual and inertial orientation tracking.

2. Description of the Related Art

In today's marketplace, various handheld devices are available that allow users to capture panoramic photographs. These handheld devices include portable digital cameras as well as mobile devices with built-in cameras, such as smartphones and tablet computers. In operation, panoramic photographs are captured by sweeping the handheld device in a given direction while the camera within the handheld device captures a series of images. A processing unit in the handheld device then “stitches” the images together to provide a single final panoramic image.

Inertial sensors within the handheld device provide information to the processing unit as to the acceleration, orientation, and direction of the handheld device at the time each image is captured. This inertial sensor information is analyzed by the processing unit to correctly stitch the images into the final panoramic image. For example, the view from a mountain top could be generated by sweeping the handheld device horizontally during a panoramic capture. Likewise, an image of a tall building could be generated by sweeping the handheld device vertically during a panoramic capture. This technique may be employed to create a cylindrical panorama, where the final image appears to be projected on the inside of a cylinder.

Some handheld devices offer another panoramic mode where the camera may be swept both vertically and horizontally during panoramic capture. This technique may be employed to create a spherical panorama, which may contain images captured from many viewpoints that are then combined into a single representation of the entire scene. With a spherical panorama, the final image appears to be projected on the inside of a sphere.

In order to create a panoramic image, a user selects either the cylindrical or spherical panoramic mode and then captures a series of images while sweeping the handheld device in an appropriate manner, based on the selected panoramic mode and the scene being captured. Once the series of images is captured, a processing unit stitches the images together, according to the selected mode, and creates a final panoramic image. If the final image does not appear as the user intended, then the user captures a new series of images, adjusting the sweeping motions to create an improved final image. The process continues until the final generated image is acceptable to the user.

One drawback of the above approach of creating panoramic images is that a user is limited to capturing panoramic images in only a single mode at a time. That is, a user may capture either a cylindrical panorama or a spherical panorama. If the user desires to capture both a cylindrical panorama and a spherical panorama, the user performs two captures—one for each of the two modes. Another drawback of the above approach is that inertial sensors in many handheld devices are subject to drift over the course of a panoramic capture. As a result, the actual position, orientation, and direction of the handheld device may differ from the position, orientation, and direction reported to the processing unit by the inertial sensors. This difference in actual and reported direction may result in misalignment of source images in the final panorama, which may render the final image unacceptable to the user. Yet another drawback of the above approach is that the user does not see the panoramic image until after the series of images is captured and the processing unit generates the final panorama. As a result, the user does not know whether a mistake was made during sweep and image capture until after the processing unit generates the image. If the image does not appear as the user intended, then the previously captured series of images has to be discarded, and a new image capture process must be performed, which results in wasted time during panoramic image capture.

As the foregoing illustrates, what is needed in the art is a more effective approach to capturing panoramic images with handheld devices.

### SUMMARY OF THE INVENTION

One embodiment of the present invention sets forth a method for generating a panoramic image from a plurality of source images. The method includes sampling a first source image included in the plurality of source images to generate a first proxy image. The method further includes sampling a second source image included in the plurality of source images to generate a second proxy image. The method further includes sampling inertial measurement information associated with at least one of the first proxy image and the second proxy image. The method further includes detecting a feature that is present in both the first proxy image and the second proxy image. The method further includes blending the second proxy image into the first proxy image based on the inertial measurement information and a first position of the feature within the second proxy image relative to a second position of the feature within the first proxy image to generate a preview image. Finally, the method includes .rendering the preview image according to a first panoramic mode to generate a first partial display image.

Other embodiments include, without limitation, a subsystem configured to implement one or more aspects of the present invention and a computing device configured to implement one or more aspects of the present invention.

One advantage of the disclosed techniques is that users preview a panoramic image during capture. The user may alter the sweeping pattern of the handheld device to capture missing images or may terminate the capture if the preview indicates an error in the proxy of the final image. As a result, panoramic images are captured more efficiently and with greater accuracy relative to previous approaches.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 is a block diagram of the GPU 112 of FIG. 1, according to one embodiment of the present invention;

FIG. 3 is a block diagram of a panoramic analysis engine, according to one embodiment of the present invention;

FIG. 4 illustrates a handheld device configured to capture and preview panoramic images, according to one embodiment of the present invention; and

FIGS. 5A-5B set forth a flow diagram of method steps for generating a panoramic image from a plurality of source images, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

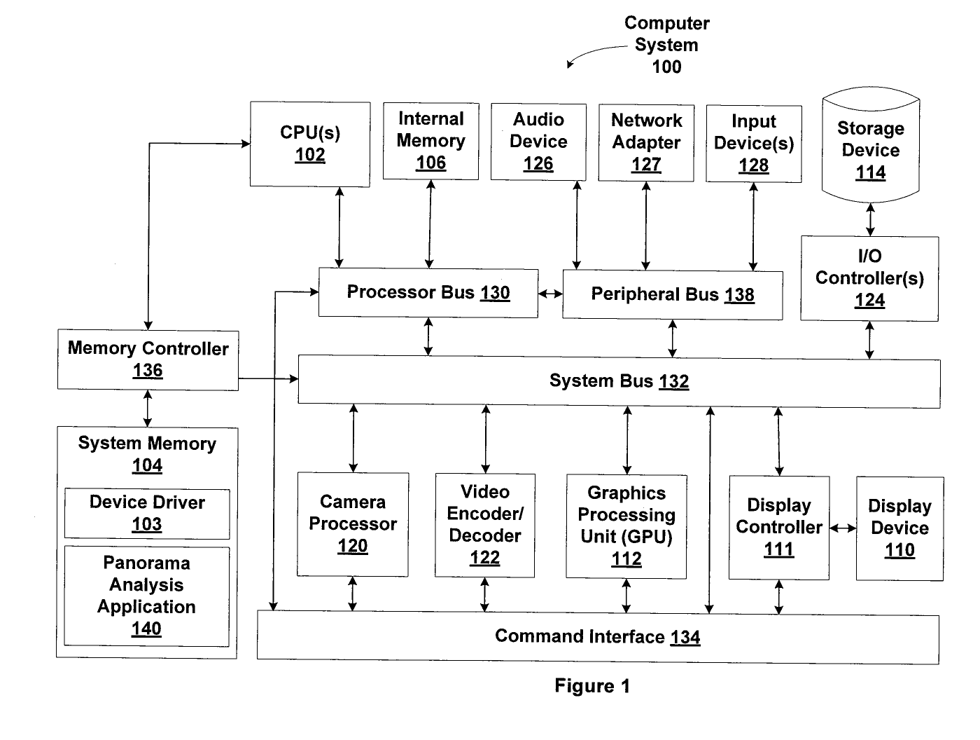

FIG. 1 is a block diagram illustrating a computer system 100 configured to implement one or more aspects of the present invention. As shown, computer system 100 includes, without limitation, one or more central processing units (CPUs) 102 coupled to a system memory 104 via a memory controller 136. The CPU(s) 102 may further be coupled to internal memory 106 via a processor bus 130. The internal memory 106 may include internal read-only memory (IROM) and/or internal random access memory (IRAM). Computer system 100 further includes a processor bus 130, a system bus 132, a command interface 134, and a peripheral bus 138. System bus 132 is coupled to a camera processor 120, video encoder/decoder 122, graphics processing unit (GPU) 112, display controller 111, processor bus 130, memory controller 136, and peripheral bus 138. System bus 132 is further coupled to a storage device 114 via an I/O controller 124. Peripheral bus 138 is coupled to audio device 126, network adapter 127, and input device(s) 128.

In operation, the CPU(s) 102 are configured to transmit and receive memory traffic via the memory controller 136. The CPU(s) 102 are also configured to transmit and receive I/O traffic and communicate with devices connected to the system bus 132, command interface 134, and peripheral bus 138 via the processor bus 130. For example, the CPU(s) 102 may write commands directly to devices via the processor bus 130. Additionally, the CPU(s) 102 may write command buffers to system memory 104. The command interface 134 may then read the command buffers from system memory 104 and write the commands to the devices (e.g., camera processor 120, GPU 112, etc.). The command interface 134 may further provide synchronization for devices to which it is coupled.

The system bus 132 includes a high-bandwidth bus to which direct-memory clients may be coupled. For example, I/O controller(s) 124 coupled to the system bus 132 may include high-bandwidth clients such as Universal Serial Bus (USB) 2.0/3.0 controllers, flash memory controllers, and the like. The system bus 132 also may be coupled to middle-tier clients. For example, the I/O controller(s) 124 may include middle-tier clients such as USB 1.x controllers, multi-media card controllers, Mobile Industry Processor Interface (MIPI®) controllers, universal asynchronous receiver/transmitter (UART) controllers, and the like. As shown, the storage device 114 may be coupled to the system bus 132 via I/O controller 124. The storage device 114 may be configured to store content and applications and data for use by CPU(s) 102, GPU 112, camera processor 120, etc. As a general matter, storage device 114 provides non-volatile storage for applications and data and may include fixed or removable hard disk drives, flash memory devices, and CD-ROM (compact disc read-only-memory), DVD-ROM (digital versatile disc-ROM), Blu-ray, or other magnetic, optical, or solid state storage devices.

The peripheral bus 138 may be coupled to low-bandwidth clients. For example, the input device(s) 128 coupled to the peripheral bus 138 may include touch screen devices, keyboard devices, sensor devices, etc. that are configured to receive information (e.g., user input information, location information, orientation information, etc.). The input device(s) 128 may be coupled to the peripheral bus 138 via a serial peripheral interface (SPI), inter-integrated circuit (I2C), and the like.

In various embodiments, system bus 132 may include an AMBA High-performance Bus (AHB), and peripheral bus 138 may include an Advanced Peripheral Bus (APB). Additionally, in other embodiments, any device described above may be coupled to either of the system bus 132 or peripheral bus 138, depending on the bandwidth requirements, latency requirements, etc. of the device. For example, multi-media card controllers may be coupled to the peripheral bus 138.

A camera (not shown) may be coupled to the camera processor 120. The camera processor 120 includes an interface, such as a MIPI® camera serial interface (CSI). The camera processor 120 may further include an encoder preprocessor (EPP) and an image signal processor (ISP) configured to process images received from the camera. The camera processor 120 may further be configured to forward processed and/or unprocessed images to the display controller 111 via the system bus 132. In addition, the system bus 132 and/or the command interface 134 may be configured to receive information, such as synchronization signals, from the display controller 111 and forward the information to the camera.

In some embodiments, GPU 112 is part of a graphics subsystem that renders pixels for a display device 110 that may be any conventional cathode ray tube, liquid crystal display, light-emitting diode display, or the like. In such embodiments, the GPU 112 and/or display controller 111 incorporates circuitry optimized for graphics and video processing, including, for example, video output circuitry such as a high-definition multimedia interface (HDMI) controller, a MIPI® display serial interface (DSI) controller, and the like. In other embodiments, the GPU 112 incorporates circuitry optimized for general purpose and/or compute processing. Such circuitry may be incorporated across one or more general processing clusters (GPCs) included within GPU 112 that are configured to perform such general purpose and/or compute operations. System memory 104 includes at least one device driver 103 configured to manage the processing operations of the GPU 112. System memory 104 also includes a panorama analysis application 140 with modules configured to execute on the CPU 102, on the GPU 112, or on both the CPU 102 and the GPU 112. The CPU 102 and the GPU 112, when executing the panorama analysis application 140, receive a series of images from the camera processor 120, along with velocity, orientation, and directional information from an inertial measurement unit (IMU). A panoramic preview image is generated from the received images and velocity, orientation, and directional information. The panoramic preview image is then transmitted to the display controller 111 for display on the display device 110. In some embodiments, a live video feed of the received images from the camera processor may also be transmitted to the display controller 111 for display on the display device 110.

In various embodiments, GPU 112 may be integrated with one or more of the other elements of FIG. 1 to form a single hardware block For example, GPU 112 may be integrated with the display controller 111, camera processor 120, video encoder/decoder, audio device 126, and/or other connection circuitry included in the computer system 100.

It will be appreciated that the system shown herein is illustrative and that variations and modifications are possible. The connection topology, including the number and arrangement of buses, the number of CPUs 102, and the number of GPUs 112, may be modified as desired. For example, the system may implement multiple GPUs 112 having different numbers of processing cores, different architectures, and/or different amounts of memory. In implementations where multiple GPUs 112 are present, those GPUs may be operated in parallel to process data at a higher throughput than is possible with a single GPU 112. Systems incorporating one or more GPUs 112 may be implemented in a variety of configurations and form factors, including, without limitation, desktops, laptops, handheld personal computers or other handheld devices, servers, workstations, game consoles, embedded systems, and the like. In some embodiments, the CPUs 102 may include one or more high-performance cores and one or more low-power cores. In addition, the CPUs 102 may include a dedicated boot processor that communicates with internal memory 106 to retrieve and execute boot code when the computer system 100 is powered on or resumed from a low-power mode. The boot processor may also perform low-power audio operations, video processing, math functions, system management operations, etc.

In various embodiments, the computer system 100 may be implemented as a system on chip (SoC). In some embodiments, CPU(s) 102 may be connected to the system bus 132 and/or the peripheral bus 138 via one or more switches or bridges (not shown). In still other embodiments, the system bus 132 and the peripheral bus 138 may be integrated into a single bus instead of existing as one or more discrete buses. Lastly, in certain embodiments, one or more components shown in FIG. 1 may not be present. For example, I/O controller(s) 124 may be eliminated, and the storage device 114 may be a managed storage device that connects directly to the system bus 132. Again, the foregoing is simply one example modification that may be made to computer system 100. Other aspects and elements may be added to or removed from computer system 100 in various implementations, and persons skilled in the art will understand that the description of FIG. 1 is exemplary in nature and is not intended in any way to limit the scope of the present invention.

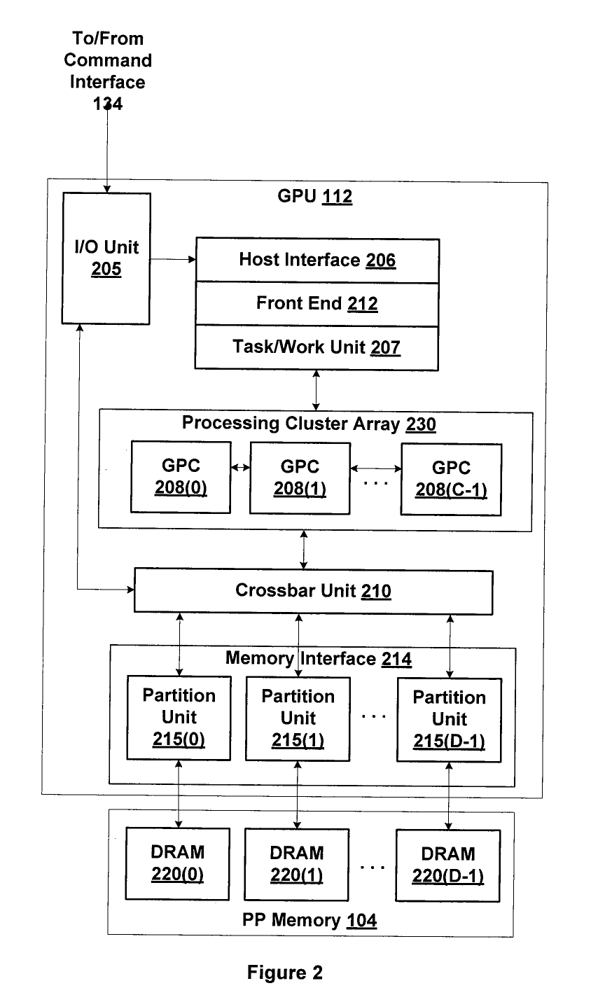

FIG. 2 is a block diagram of the GPU 112 of FIG. 1, according to one embodiment of the present invention. Although FIG. 2 depicts one GPU 112 having a particular architecture, any technically feasible GPU architecture falls within the scope of the present invention. Further, as indicated above, the computer system 100 may include any number of GPUs 112 having similar or different architectures. GPU 112 may be implemented using one or more integrated circuit devices, such as one or more programmable processor cores, application specific integrated circuits (ASICs), or memory devices. In implementations where system 100 comprises an SoC, GPU 112 may be integrated within that SoC architecture or in any other technically feasible fashion.

In some embodiments, GPU 112 may be configured to implement a two-dimensional (2D) and/or three-dimensional (3D) graphics rendering pipeline to perform various operations related to generating pixel data based on graphics data supplied by CPU(s) 102 and/or system memory 104. In other embodiments, 2D graphics rendering and 3D graphics rendering are performed by separate GPUs 112. When processing graphics data, one or more DRAMs 220 within system memory 104 can be used as graphics memory that stores one or more conventional frame buffers and, if needed, one or more other render targets as well. Among other things, the DRAMs 220 within system memory 104 may be used to store and update pixel data and deliver final pixel data or display frames to display device 110 for display. In some embodiments, GPU 112 also may be configured for general-purpose processing and compute operations.

In operation, the CPU(s) 102 are the master processor(s) of computer system 100, controlling and coordinating operations of other system components. In particular, the CPU(s) 102 issue commands that control the operation of GPU 112. In some embodiments, the CPU(s) 102 write streams of commands for GPU 112 to a data structure (not explicitly shown in either FIG. 1 or FIG. 2) that may be located in system memory 104 or another storage location accessible to both CPU 102 and GPU 112. A pointer to the data structure is written to a pushbuffer to initiate processing of the stream of commands in the data structure. The GPU 112 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, GPU 112 includes an I/O (input/output) unit 205 that communicates with the rest of computer system 100 via the command interface 134 and system bus 132. I/O unit 205 generates packets (or other signals) for transmission via command interface 134 and/or system bus 132 and also receives incoming packets (or other signals) from command interface 134 and/or system bus 132, directing the incoming packets to appropriate components of GPU 112. For example, commands related to processing tasks may be directed to a host interface 206, while commands related to memory operations (e.g., reading from or writing to system memory 104) may be directed to a crossbar unit 210. Host interface 206 reads each pushbuffer and transmits the command stream stored in the pushbuffer to a front end 212.

As mentioned above in conjunction with FIG. 1, how GPU 112 is connected to or integrated with the rest of computer system 100 may vary. For example, GPU 112 can be integrated within a single-chip architecture via a bus and/or bridge, such as system bus 132. In other implementations, GPU 112 may be included on an add-in card that can be inserted into an expansion slot of computer system 100.

During operation, in some embodiments, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end unit 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

In various embodiments, GPU 112 advantageously implements a highly parallel processing architecture based on a processing cluster array 230 that includes a set of C general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 may include a set of D of partition units 215, where D≧1. Each partition unit 215 is coupled to the one or more dynamic random access memories (DRAMs) 220 residing within system memory 104. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. As previously indicated herein, in operation, various render targets, such as texture maps and frame buffers, may be stored across DRAMs 220, allowing partition units 215 to write portions of each render target in parallel to efficiently use the available bandwidth of system memory 104.

A given GPC 208 may process data to be written to any of the DRAMs 220 within system memory 104. Crossbar unit 210 is configured to route the output of each GPC 208 to any other GPC 208 for further processing. Further GPCs 208 are configured to communicate via crossbar unit 210 to read data from or write data to different DRAMs 220 within system memory 104. In one embodiment, crossbar unit 210 has a connection to I/O unit 205, in addition to a connection to system memory 104, thereby enabling the processing cores within the different GPCs 208 to communicate with system memory 104 or other memory not local to GPU 112. In the embodiment of FIG. 2, crossbar unit 210 is directly connected with I/O unit 205. In various embodiments, crossbar unit 210 may use virtual channels to separate traffic streams between the GPCs 208 and partition units 215.

Although not shown in FIG. 2, persons skilled in the art will understand that each partition unit 215 within memory interface 214 has an associated memory controller (or similar logic) that manages the interactions between GPU 112 and the different DRAMs 220 within system memory 104. In particular, these memory controllers coordinate how data processed by the GPCs 208 is written to or read from the different DRAMs 220. The memory controllers may be implemented in different ways in different embodiments. For example, in one embodiment, each partition unit 215 within memory interface 214 may include an associated memory controller. In other embodiments, the memory controllers and related functional aspects of the respective partition units 215 may be implemented as part of memory controller 136. In yet other embodiments, the functionality of the memory controllers may be distributed between the partition units 215 within memory interface 214 and memory controller 136.

In addition, in certain embodiments that implement virtual memory, CPUs 102 and GPU(s) 112 have separate memory management units and separate page tables. In such embodiments, arbitration logic is configured to arbitrate memory access requests across the DRAMs 220 to provide access to the DRAMs 220 to both the CPUs 102 and the GPU(s) 112. In other embodiments, CPUs 102 and GPU(s) 112 may share one or more memory management units and one or more page tables.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, GPU 112 is configured to transfer data from system memory 104, process the data, and write result data back to system memory 104. The result data may then be accessed by other system components, including CPU 102, another GPU 112, or another processor, controller, etc. within computer system 100.

### Interactive Panoramic Photography

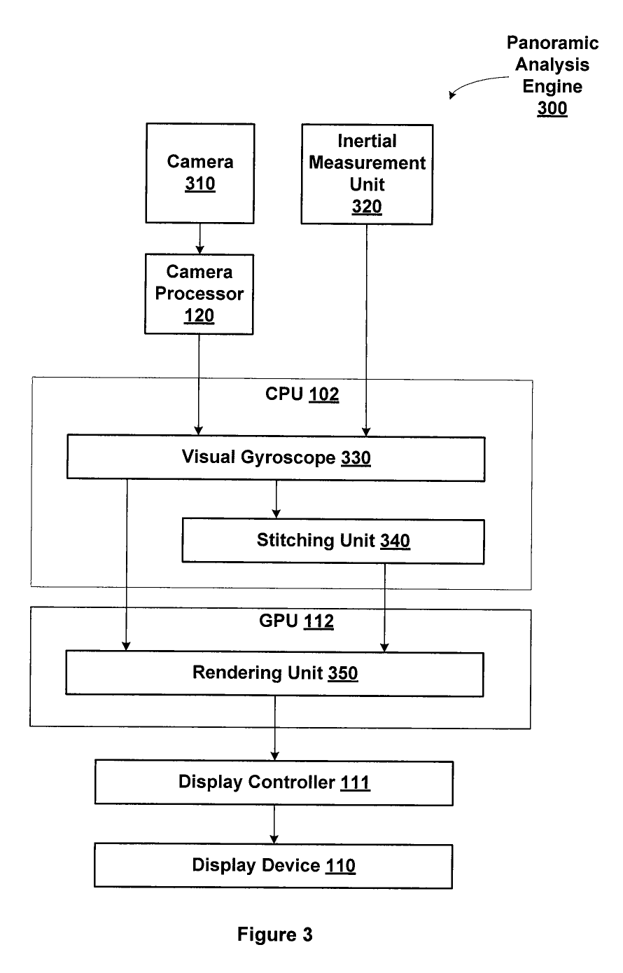

FIG. 3 is a block diagram of a panoramic analysis engine 300, according to one embodiment of the present invention. Persons skilled in the art will recognize that all or part of the computer system 100 may be implemented within the panoramic analysis engine 300 in various embodiments. As shown, the panoramic analysis engine 300 includes a camera 310, a camera processor 120, an inertial measurement unit 320, a CPU 102, a GPU 112, a display controller 111, and a display device 110. The camera processor 120, the inertial measurement unit 320, the CPU 102, the GPU 112, the display controller 111, and the display device 110 function substantially the same as described in FIGS. 1-2, except as further described below.

The camera 310 acquires light via a front-facing or back facing lens and converts the acquired light into one or more analog or digital images for processing by other stages in the panoramic analysis engine 300. The camera 310 may include any of a variety of optical sensors including, without limitation, complementary metal-oxide-semiconductor (CMOS) or charge-coupled device (CCD) sensors. The camera 310 may include functionality to determine and configure optical properties and settings including, without limitation, focus, exposure, color or white balance, and area of interest identification. The camera 310 transmits acquired images to the camera processor 120. In one embodiment, the camera 310 acquires images at a rate sufficient to transmit a live video feed to the camera processor 120.

The camera processor 120 may apply one or more processing functions to an acquired image, including, without limitation, color correction, color space conversion, and image stabilization to the images acquired by the camera 310. The camera processor 120 transmits the processed images to the CPU 102. In one embodiment, each image transmitted by the camera processor 120 is associated with a time value that identifies the time at which the image was acquired by the camera 310.

The inertial measurement unit 320 measures the velocity, orientation and gravitational forces of a handheld device. The inertial measurement unit 320 performs these measurements using a combination of inputs from other devices, including, without limitation, an accelerometer, a gyroscope and a magnetometer. An accelerometer detects acceleration forces along a single axis. In some embodiments, the inertial measurement unit 320 includes three accelerometers to provide acceleration information along the x, y and z axis. A gyroscope detects changes in rotational attributes, such as pitch, roll, and yaw. A magnetometer detects the strength and direction of magnetic fields. A magnetometer may be used for tracking magnetic north, thereby functioning as a compass. Alternatively, a digital compass may provide directional information for the handheld device. The inertial measurement unit 320 transmits the resulting velocity, orientation, and directional information to the CPU 102.

The CPU 102 performs one or more functions on the images received from the camera processor 120 and the information received from the inertial measurement unit 320. As shown, the CPU 102 includes a visual gyroscope 330 and a stitching unit 340. In one embodiment, the CPU 102 performs the functions of the visual gyroscope 330 and the stitching unit 340 by executing one or more functional modules of the panorama analysis application 140 of FIG. 1.

The visual gyroscope 330 processes the time-stamped images received from the camera processor 120 and the velocity, orientation, and directional information received from the inertial measurement unit 320. For each received image, the visual gyroscope 330 detects visual features that are repeatable and distinct within the image. The visual gyroscope 330 then performs a feature description process for the features found during the feature detection process. Feature description includes detecting and describing local features in received images. For example, for each object detected in a received image, points of interest on the object could be extracted to provide a feature description of the object. This description could be determined from a training image. Such a training image would then be used to identify the object when attempting to locate the object in a received image that includes other objects. Accordingly, feature detection finds features in the received image while feature description associates each detected feature with an identifier.

The visual gyroscope 330 performs feature detection and feature description on a subset of the received images. Such images in the subset of received images are referred to as keyframe images. Keyframe images are selected based on detecting when the movement of the handheld device, such as lateral movement or rotation, exceeds a threshold value. A particular feature may be tracked from keyframe image to keyframe image by locating the identifier associated with the particular feature in each keyframe image where the feature appears. In order to determine if the movement of the handheld exceeds the threshold, the visual gyroscope 330 matches features between the current keyframe image and the prior keyframe image. If one or more features are found in both keyframe images, then the visual gyroscope 330 computes a rotation between the two keyframe images based on the relative positions of the matched features. In one embodiment, the visual gyroscope 330 downsamples the received images prior to selecting keyframe images and performing feature detection and description. The visual gyroscope 330 combines or “fuses” the visual feature information derived from the received images with inertial measurement information received from the inertial measurement unit 320 to generate stabilized orientation data. The inertial measurement information, by itself, is subject to drift because of the nature of the measuring instruments. Likewise, visual feature information, by itself, may lack a sufficient quantity of matched features. As a result, improved stitching is achieved, as compared with stitching based on either inertial measurement information or visual feature information alone. The visual gyroscope 330 transmits stabilized orientation data, object detection and description data, and keyframe images to the stitching unit 340. The visual gyroscope 330 also transmits stabilized orientation data and live video to the GPU 112.

The stitching unit 340 combines the received keyframe images into a panoramic image. The stitching unit 340 performs pairwise feature matching between a received keyframe image and the current panoramic image where the received keyframe overlaps one or more regions of the current panoramic image. The stitching unit 340 employs such matching features to register the received keyframe with respect to the current panoramic image. The stitching unit 340 then performs image calibration to properly integrate the received keyframe image within the panoramic image, accounting for aberrations, distortions, and other optical defects in the lens of the camera 310, exposure differences between keyframes, and chromatic differences between keyframes. The stitching unit 340 performs various blending functions on the received keyframe, based on information calculated during the image calibration process. Such blending functions include, without limitation, image warping, color correction, luminance adjustment, and motion compensation. The blended keyframe is then composited, or overlayed, on the panoramic image. The stitching unit 340 then transmits the panoramic image to the GPU 112. In some embodiments, the stitching unit 340 may transmit reduced resolution panoramic preview images to the GPU 112 during panoramic image capture. Once panoramic image capture completes, the stitching unit 340 may perform a finalization pass on the full resolution source images, based on the registration, calibration, and blending data calculated during panoramic image capture.

The GPU 112 performs one or more functions on the live video and orientation information received from the visual gyroscope 330 and the preview panoramic image from the stitching unit 340. As shown, the GPU 112 includes a rendering unit 350. In one embodiment, the GPU 112 performs the functions of the rendering unit 350 by executing one or more functional modules of the panorama analysis application 140 of FIG. 1.

The rendering unit 350 receives stabilized orientation data and live video from the visual gyroscope 330. The rendering unit 350 also receives panoramic preview images and panoramic full-resolution images from the stitching unit 340. The rendering unit 350 renders the received panoramic images via any technically feasible projection mode, including, without limitation.

In one embodiment, a single projection mode may be employed throughout the capture, generation, and display of a panoramic image. In another embodiment, the projection mode may be changed one or more times throughout the capture, generation, and display of a panoramic image. In this embodiment, the preview panoramic image generated via one projection mode may be replaced by a corresponding panoramic image generated via a different projection mode. In yet another embodiment, one display window may display the preview panoramic image generated via one projection mode, and a second display window may simultaneously display the preview panoramic image generated via a different projection mode.

The rendering unit 350 composites the live video and panoramic images into display windows and transmits the rendered images and display windows to the display controller 111, which, in turn, transmits picture elements (pixels) to the display device 110 for display.

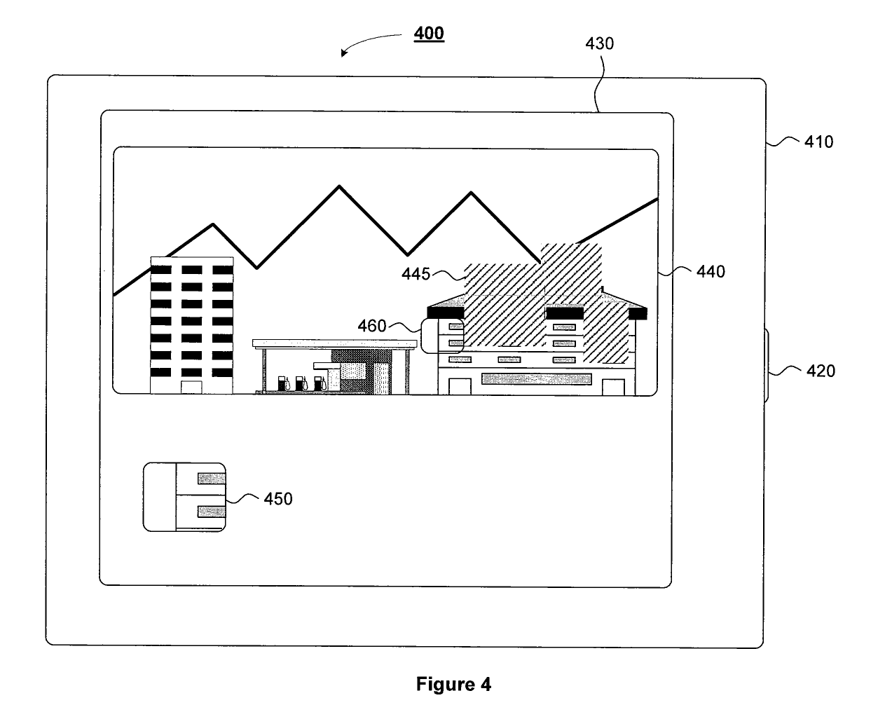

FIG. 4 illustrates a handheld device 400 configured to capture and preview panoramic images, according to one embodiment of the present invention. Persons skilled in the art will recognize that all or part of the panoramic analysis engine 300 may be implemented within the handheld device 400 in various embodiments. As shown, the handheld device 400 includes an enclosure 410, a capture button 420, a display 430, a preview window 440, and a live window 450.

The enclosure 410 houses the various components of the handheld device 400, including, without limitation, the capture button 420, the display 430, and the various components of the panoramic analysis engine 300. The capture button 420, typically located on one side of the enclosure 410, is an input device that identifies when a user of the handheld device intends to capture one or more images via the camera 310. Pressing and releasing the capture button 420 causes the handheld device 400 to capture a single image. If the handheld device 400 is not in a panoramic capture mode, then pressing and holding the capture button 420 causes the handheld device 400 to capture a video image. If the handheld device 400 is in a panoramic capture mode, then pressing and holding the capture button 420 causes the handheld device 400 to capture a panoramic image.

The display 430 includes one or more windows for displaying images captured by the camera 310. The display 430 may also include a graphical user interface (not shown) by which a user may select various modes or adjust various parameters. For example, the display 430 could include a graphical user interface where the user could select one of a number of projection modes. The projection modes could include, without limitation, a cylindrical mode, a spherical mode, a planar mode, a rectilinear mode, or a fisheye mode. When the user selects a new projection mode, the panoramic image in the preview window 440 changes to reflect the selected panoramic mode.

The preview window 440 illustrates the progress of a current panoramic image capture. The preview window 440 begins to update when the user presses and holds the capture button 420 during a panoramic capture mode. The preview window 440 displays the current panoramic image according to a selected projection mode. The preview window 440 updates as the user sweeps the handheld device 400 vertically and horizontally to capture the desired scene. The current view window 460 illustrates the region of the scene at which the handheld device 400 is currently pointed. The uncaptured region 445 illustrates a portion of the scene that is not yet captured. One or more uncaptured regions 445 in the preview window 440 indicate that the panoramic image capture is not yet complete.

The preview window 440 and the current view window 460 serve as a guide to the user as to the progress of the panoramic image capture. The user sweeps the handheld device 400 to move the current view window 460 over surface area corresponding to the uncaptured region 445, capturing images to fill in the uncaptured region. The user continues to hold the capture button 420 while sweeping the handheld device 400 in order to capture scene portions represented by the uncaptured region 445. If the user moves the handheld device 400 such that the current view window 460 covers a portion of the scene that has already been captured, then the new image data corresponding to the covered portion of the screen may be discarded. Alternatively, if the user moves the handheld device 400 such that the current view window 460 covers a portion of the scene that has already been captured, then the new image data corresponding to the covered portion of the screen may replace or be blended with the existing image data corresponding to the covered portion.

The preview window 440 may continuously update the preview window with a low-resolution proxy of the panoramic image, showing the areas of the scene that are not yet captured, while the handheld device 400 is currently capturing a panoramic image. When the entire area of the uncaptured region 445 has been filled in with image data, the preview window 440 depicts a fully captured image with no uncaptured region 445. The user then releases the capture button 420 on the handheld device 400 to complete the panoramic image capture. In some embodiments, the panoramic analysis engine 300 generates a full resolution panoramic image when the user releases the capture button 420. The preview window 430 then updates to display the full resolution panoramic image.

The live window 450 displays live captured video when the handheld device is in panoramic capture mode. The live window 450 illustrates the region of the scene at which the handheld device 400 is currently pointed. In some embodiments, the image displayed in the live window 450 is a larger, live version of the image displayed in the current view window 460.

In one embodiment, the live video and panoramic images generated by the handheld device 400 may be displayed on one or more remotely located display devices. For example, a first user could capture a panoramic image with a handheld device 400 when the user is at a particular location of interest, such as a concert, speech or other live event. The user could observe the preview window 440 to determine when the panoramic image is complete. The user could then focus the handheld device 400 at a particular object within the scene, such as a concert stage or a lectern. The live window 450 would then display a live feed of the concert, speech, or other event. The contents of the display 430 could be transmitted to one or more remotely located devices, enabling other viewers to observe the preview window 440 and the live window 450 at locations remotely located from the concert, speech, or other live event. In some embodiments, each viewer may operate controls to navigate throughout the captured panoramic image, updating the preview window 440 as the viewer navigates through the panoramic image.

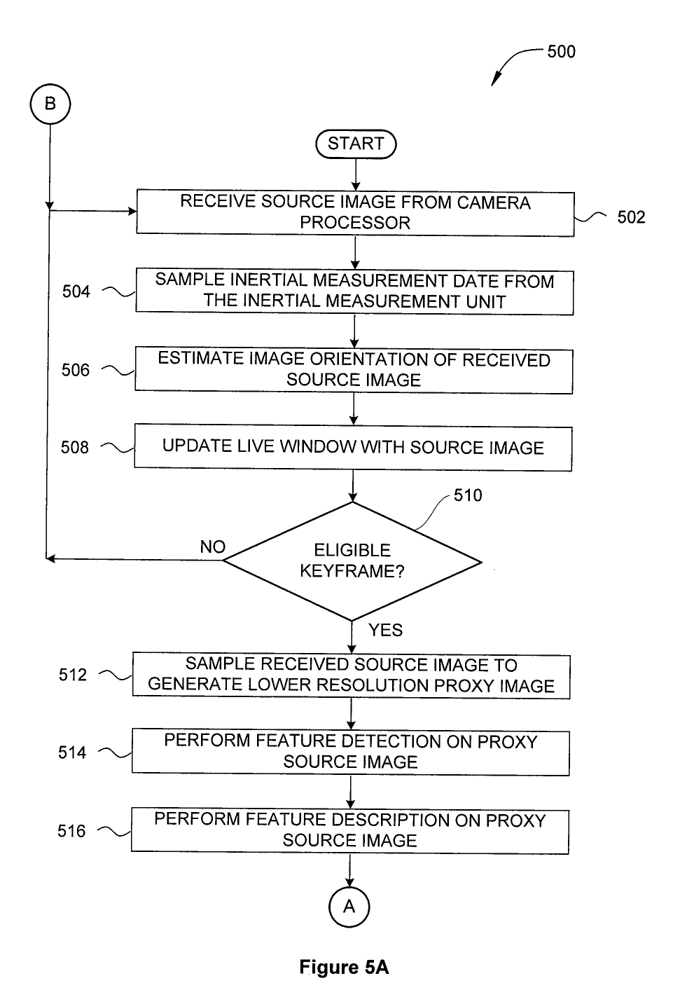

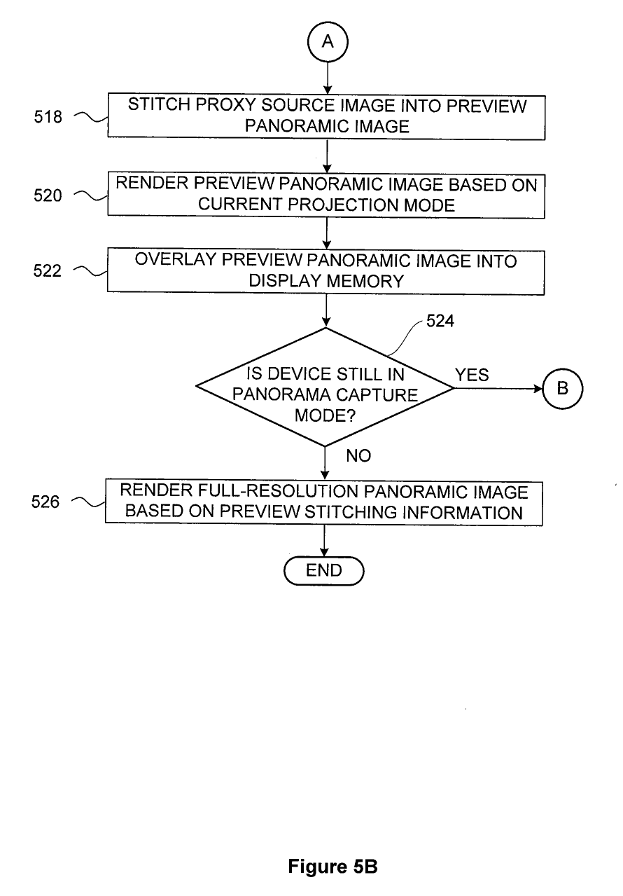

FIGS. 5A-5B set forth a flow diagram of method steps for generating a panoramic image from a plurality of source images, according to one embodiment of the present invention. Although the method steps are described in conjunction with the systems of FIGS. 1-4, persons skilled in the art will understand that any system configured to perform the method steps, in any order, falls within the scope of the present invention.

As shown, a method 500 begins at step 502, where the panoramic analysis engine 300 receives a source image from the camera processor 120. Typically, the source image has been captured by a camera 310 in a handheld device and processed by the camera processor 120. At step 504, the panoramic analysis engine 300 samples inertial measurement information received from the inertial measurement unit 320. At step 506, the panoramic analysis engine 300 estimates the image orientation of received source image based on the source image, inertial measurement information and the time the received source image was captured. At step 508, the panoramic analysis engine 300 updates a live window in the display memory with the received source image. At step 510, the panoramic analysis engine 300 determines whether the received source image is an eligible keyframe based on whether the translation or rotation of the handheld device 400 since the last keyframe exceeds a threshold. If the received source image is not an eligible keyframe, then the method 500 proceeds to step 502, described above.

If, however, at step 510, the received source image is an eligible keyframe, then the method 500 proceeds to step 512, where the panoramic analysis engine 300 downsamples the received source image to generate a lower resolution proxy image. At step 514, the panoramic analysis engine 300 performs feature detection on the received source image. At step 516, the panoramic analysis engine 300 performs feature description on the received source image. At step 518, the panoramic analysis engine 300 stitches the received source image into a preview panoramic image. At step 520, the panoramic analysis engine 300 renders the preview panoramic image based on the current projection mode. At step 522, the panoramic analysis engine 300 overlays the preview panoramic image into display memory. At step 524, the panoramic analysis engine 300 determines whether the handheld device 400 is still in panorama capture mode. If the panoramic analysis engine 300 determines that the handheld device 400 is still in panorama capture mode, then the method 500 proceeds to step 502, described above.

If, however, the panoramic analysis engine 300 determines that the handheld device 400 is not still in panorama capture mode, then the method 500 proceeds to step 526, where the panoramic analysis engine 300 renders a full-resolution panoramic image based on the preview stitching information. The method 500 then terminates.

In sum, panoramic images are displayed on a handheld device during image capture. A low-resolution proxy of the panoramic image is displayed and updated to show regions of the panoramic scene that are captured. Blank areas of the displayed panoramic image indicate regions of the panoramic scene that are not yet captured. The user sweeps the handheld device vertically and horizontally to complete the panoramic capture, using the displayed panoramic image as a guide. If the displayed panoramic image indicates an artifact or undesirable capture, the user may interrupt the current panoramic image capture and initiate a new panoramic capture. During or after capture, the user may change the displayed image from one projection mode to another projection mode, allowing the user to interactively visualize the panoramic image under various projection modes.

One advantage of the disclosed techniques is that users preview a panoramic image during capture. The user may alter the sweeping pattern of the handheld device to capture missing images or may terminate the capture if the preview indicates an error in the proxy of the final image. As a result, panoramic images are captured more efficiently and with greater accuracy relative to previous approaches. Another advantage of the disclosed techniques is that the panoramic mode may be modified during capture, allowing the user to visualize a proxy of the final image in various modes as the series of images is captured.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

What is claimed is:

1. A method for generating a panoramic image from a plurality of source images, the method comprising:
sampling a first source image included in the plurality of source images to generate a first proxy image;
sampling a second source image included in the plurality of source images to generate a second proxy image;
sampling inertial measurement information associated with at least one of the first proxy image and the second proxy image;
detecting a feature that is present in both the first proxy image and the second proxy image;
blending the second proxy image into the first proxy image based on the inertial measurement information and a first position of the feature within the second proxy image relative to a second position of the feature within the first proxy image to generate a preview image; and
rendering the preview image according to a first panoramic mode to generate a first partial display image.

2. The method of claim 1, further comprising:
estimating a first orientation for the first source image;
estimating a second orientation for the second source image; and
determining that the second orientation differs from the first orientation by a threshold amount.

3. The method of claim 1, wherein the first projection mode comprises a cylindrical mode, a spherical mode, a planar mode, a rectilinear mode, or a fisheye mode.

4. The method of claim 1, further comprising causing the first partial display image to be displayed within a first window on a display.

5. The method of claim 4, further comprising causing the first proxy image and the second proxy image to be consecutively displayed within a second window on the display.

6. The method of claim 4, further comprising:
rendering the preview image according to a second panoramic mode to generate a second partial display image; and
causing the second partial display image to be displayed within the first window on the display.

7. The method of claim 6, wherein each of the first projection mode and the second projection mode comprises a cylindrical mode, a spherical mode, a planar mode, a rectilinear mode, or a fisheye mode.

8. The method of claim 4, further comprising:
rendering the preview image according to a second panoramic mode to generate a second partial display image; and
causing the second partial display image to be displayed within a second window on the display.

9. The method of claim 4, wherein the display is associated with a first handheld device, and further comprising storing the first partial display image in a memory that resides within a second handheld device.

10. The method of claim 1, further comprising:
blending the first source image with the second source image based on the first position of the feature in the first proxy image and the second position of the feature in the second proxy image to generate a final image; and
rendering the final image according to the first panoramic mode to generate the panoramic image.

11. A computing device, comprising:
a processor configured to:
sample a first source image included in the plurality of source images to generate a first proxy image;
sample a second source image included in the plurality of source images to generate a second proxy image;
sample inertial measurement information associated with at least one of the first proxy image and the second proxy image;
detect a feature that is present in both the first proxy image and the second proxy image;
blend the second proxy image into the first proxy image based on the inertial measurement information and a first position of the feature within the second proxy image relative to a second position of the feature within the first proxy image to generate a preview image; and
rendering the preview image according to a first panoramic mode to generate a first partial display image.

12. The computing device of claim 11, wherein the first projection mode comprises a cylindrical mode, a spherical mode, a planar mode, a rectilinear mode, or a fisheye mode.

13. The computing device of claim 11, wherein the processor is further configured to cause the first partial display image to be displayed within a first window on a display.

14. The computing device of claim 13, wherein the processor is further configured to cause the first proxy image and the second proxy image to be consecutively displayed within a second window on the display.

15. The computing device of claim 13, wherein the processor is further configured to:
render the preview image according to a second panoramic mode to generate a second partial display image; and
cause the second partial display image to be displayed within the first window on the display.

16. The computing device of claim 15, wherein each of the first projection mode and the second projection mode comprises a cylindrical mode, a spherical mode, a planar mode, a rectilinear mode, or a fisheye mode.

17. The computing device of claim 13, wherein the processor is further configured to:
render the preview image according to a second panoramic mode to generate a second partial display image; and
cause the second partial display image to be displayed within a second window on the display.

18. The computing device of claim 13, wherein the display is associated with a first handheld device, and further comprising storing the first partial display image in a memory that resides within a second handheld device.

19. The computing device of claim 11, wherein the processor is further configured to:
blend the first source image with the second source image based on the first position of the feature in the first proxy image and the second position of the feature in the second proxy image to generate a final image; and
render the final image according to the first panoramic mode to generate the panoramic image.

20. A subsystem for generating a panoramic image from a plurality of source images, comprising:
a camera; and
a panoramic analysis engine configured to:
sample a first source image included in the plurality of source images to generate a first proxy image;
sample a second source image included in the plurality of source images to generate a second proxy image;
sample inertial measurement information associated with at least one of the first proxy image and the second proxy image;
detect a feature that is present in both the first proxy image and the second proxy image;
blend the second proxy image into the first proxy image based on the inertial measurement information and a first position of the feature within the second proxy image relative to a second position of the feature within the first proxy image to generate a preview image; and
rendering the preview image according to a first panoramic mode to generate a first partial display image.,
